(19) United States
(12) Patent Application Publication
(10) Pub. No.: US 2008/0181238 A1
(43) Pub. Date: Jul. 31, 2008

(54) Methods, systems, and computer program products for reducing down time while performing network modifications

(76) Inventors: Raj Raheja, Roswell, GA (US); Homayoun Torab, Lawrenceville, GA (US); Mounire El Houmaidi, Atlanta, GA (US)

Correspondence Address: CANTOR COLBURN LLP - BELLSOUTH, 20 Church Street, 22nd Floor, Hartford, CT, 06103, US

(21) Appl. No.: 11/657,884

(22) Filed: Jan. 25, 2007

(51) Int. Cl. H04L 12/56

(52) U.S. Cl. 370/401; 370/465

(57) ABSTRACT

A list of subscribers to be moved from a set of existing equipment elements to a set of new equipment elements is determined. If a network management system for managing the set of new equipment elements is capable of supporting logical provisioning of subscribers before the set of new equipment elements are placed into service, then the set of new equipment elements for the list of subscribers is preprovisioned, subscriber connections to the set of new equipment elements are installed, and the set of new equipment elements in the communications network is installed; otherwise, subscriber connections to the set of new equipment elements are installed, the set of new equipment elements is installed into the communications network, the set of new equipment elements are placed into service, and the set of new equipment elements are provisioned for the list of subscribers. Subscriber connections to the set of existing equipment elements are removed.

### BACKGROUND

The present disclosure relates generally to communications networks and, more particularly, to methods, systems, and computer program products for reducing down time while performing network modifications.

The updating of networks is mandated by technological developments which change the manner in which customers are served by communications networks. Telephonic networks that were initially developed for voice communication are now required to carry high-speed data and Internet traffic. At the same time, it is difficult or impossible to provide many customers with high speed Internet connections due to the long length of copper wire loops needed to traverse the distance between a customer premises and a telephone company central office. From time to time, it may be necessary to replace or add equipment on a communications network that is currently in use. For example, network equipment may be damaged during a natural disaster such as a tornado, hurricane, earthquake, or flood. In the absence of such disasters, a network may require updating or additional capacity, thereby necessitating placement of new elements into the network.

In view of the foregoing considerations, some communication service providers are moving towards Ethernet and Internet Protocol (IP)-based networks. However, achieving high speed service requires modifying portions of the communications network to create shorter loop lengths. As part of the modification process, new Ethernet IP access nodes may be deployed which are situated much closer to the customer premises than presently existing access nodes. This requires rewiring and reprovisioning customers from existing asynchronous transfer mode (ATM)-based network elements to new IP-based network elements.

Rewiring and reprovisioning customers is a labor-intensive process which requires extensive technician training. To further complicate matters, each new item of network equipment may require technicians to perform vendor-specific reprovisioning processes which are not scalable to larger communications networks. Customers may experience extended service outages, with some customers becoming frustrated and moving to other service providers. Such an approach is not well suited for fast deployment of new technologies and services, nor is such an approach effective for replacement of equipment in the aftermath of a natural disaster. Accordingly, what is needed is an improved technique for reducing customer down time while performing network modifications.

### SUMMARY

Embodiments include methods for reducing down time of a communications network while performing network modifications. A list of subscribers to be moved from a set of existing equipment elements to a set of new equipment elements is determined. If a network management system for managing the set of new equipment elements is capable of supporting logical provisioning of subscribers before the set of new equipment elements are placed into service, then the set of new equipment elements for the list of subscribers is preprovisioned, subscriber connections to the set of new equipment elements are installed, and the set of new equipment elements in the communications network is installed; otherwise, subscriber connections to the set of new equipment elements are installed, the set of new equipment elements is installed into the communications network, the set of new equipment elements are placed into service, and the set of new equipment elements are provisioned for the list of subscribers. Subscriber connections to the set of existing equipment elements are removed.

Embodiments further include computer program products for implementing the foregoing methods.

Additional embodiments include a system for reducing down time of a communications network while performing network modifications. A network management mechanism is capable of managing a set of new equipment elements and determining a list of subscribers to be moved from a set of existing equipment elements to the set of new equipment elements such that, if the network management mechanism is capable of supporting logical provisioning of subscribers before the set of new equipment elements are placed into service, then the network management mechanism preprovisions the set of new equipment elements for the list of subscribers before the set of new equipment elements is placed into service; otherwise, the network management mechanism provisions the set of new equipment elements for the list of subscribers after the set of new equipment elements is placed into service. The network management mechanism is operably coupled to a communications network. The network is modified by installing the set of new equipment elements in the communications network, by installing subscriber connections to the set of new equipment elements, and by removing subscriber connections to the set of existing equipment elements. The modified network is capable of providing communication service to the list of subscribers using the set of new equipment elements.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF DRAWINGS

Referring now to the drawings wherein like elements are numbered alike in the several FIGURES:

FIG. 1 depicts an illustrative communications network in which a set of existing equipment elements is to be replaced by a set of new equipment elements.

FIG. 2 shows an illustrative method for reducing the down time of a communications network while performing network modifications.

The detailed description explains exemplary embodiments of the invention, together with advantages and features, by way of example with reference to the drawings.

### DETAILED DESCRIPTION OF EXEMPLARY EMBODIMENTS

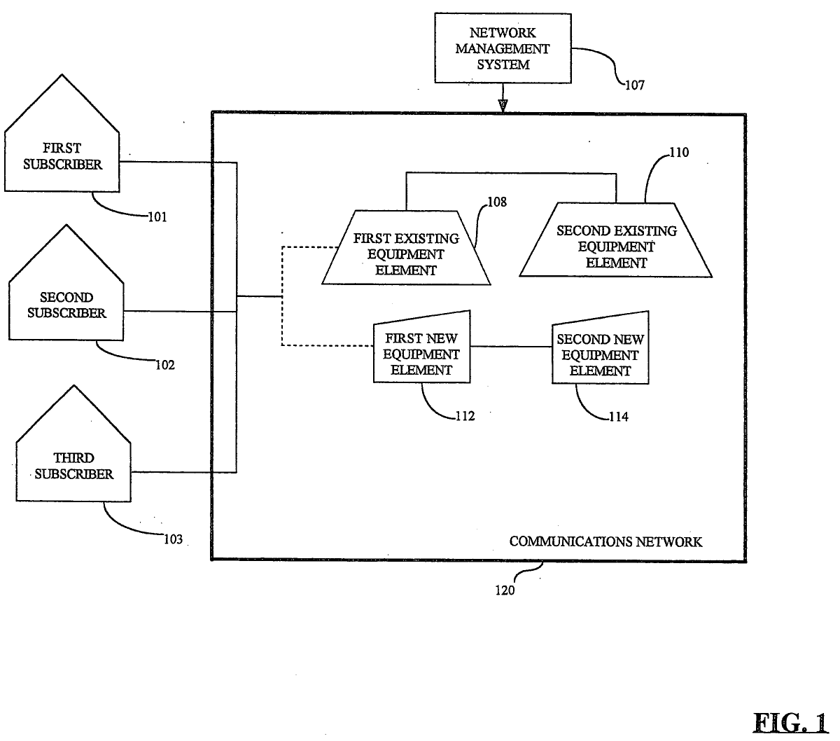

FIG. 1 depicts an illustrative communications network 120 in which a set of existing equipment elements is to be replaced by a set of new equipment elements. Communications network 120 may be implemented using any of a variety of networks and network components including, but not limited to, routers, switches, servers, the public switched telephone network (PSTN), the Internet, a cable television network, a wireless network, a satellite communications network or the like, as well as various combinations thereof. These networks and network components are equipped to communicate using one or more protocols which, for purposes of illustration, could but need not include digital subscriber line (DSL), Internet protocol (IP), WiFi (IEEE 802.11), or WiMax (IEEE 802.16). For example, one illustrative implementation for communications network 120 may include the PSTN providing voice and broadband services over a DSL connection to a plurality of subscribers such as a first subscriber 101, a second subscriber 102, and a third subscriber 103.

For illustrative purposes, the set of existing equipment elements includes a first existing equipment element 108 and a second existing equipment element 110, although any number of one or more existing equipment elements may be present. Optionally, first existing equipment element 108 and second existing equipment element 110 may, but need not, represent equipment elements that have been damaged or destroyed in a natural disaster such as a flood, earthquake, hurricane, or tornado. Exemplary implementations for first existing equipment element 108 and second existing equipment element 110 may include asynchronous transfer mode (ATM) access nodes, removable ATM network interface cards, hardware devices equipped to perform ATM-based communications, and other types of devices.

The set of new equipment elements illustratively includes a first new equipment element 112 and a second new equipment element 114, although any number of one or more new equipment elements may be present. Exemplary implementations for first new equipment element 112 and second new equipment element 114 may include Ethernet IP access nodes, removable network interface cards, hardware devices equipped to perform internet protocol (IP)-based communications, and other types of devices.

The first, second, and third subscribers 101, 102, and 103 are each receiving communication service from first and second existing equipment elements 108, 110. However, it is desired to replace first and second existing equipment elements 108, 110 with first and second new equipment elements 112, 114 while, at the same time, reducing or eliminating any resulting network down time experienced by first, second, and third subscribers 101, 102, and 103. For example, network equipment may be damaged during a natural disaster such as a tornado, hurricane, earthquake, or flood. In the absence of such disasters, a network may require updating or additional capacity, thereby necessitating placement of new elements into the network.

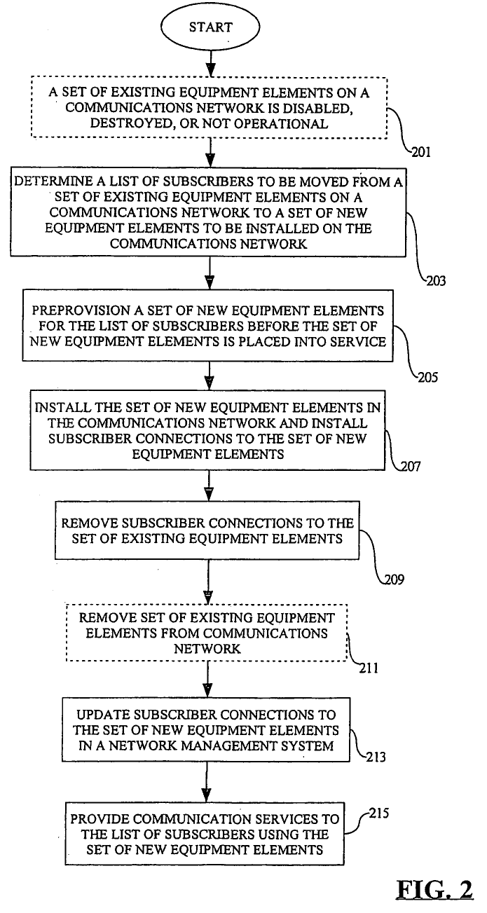

FIG. 2 shows an illustrative method for reducing the down time of a communications network while performing network modifications. Optionally, the procedure commences at block 201 where a set of existing equipment elements 108, 110 (FIG. 1) on communications network 120 is to be upgraded or removed, or services are to be transferred to new equipment elements for technology improvements or access to new services. For example, existing equipment elements may be damaged during a natural disaster such as a tornado, hurricane, earthquake, or flood. The procedure then continues to block 203.

In the absence of damage to existing equipment elements, the procedure of FIG. 2 commences at block 203 where a list of subscribers to be moved from a set of existing equipment elements 108, 110 to a set of new equipment elements 112, 114 is determined. The existing equipment elements 108, 110 are installed on communications network 120, and the new equipment elements 112, 114 are to be installed on communications network 120. The list of subscribers may be generated by or obtained from a network management system 107 operatively coupled to communications network 120, wherein network management system 107 maintains a list of subscribers served by first and second existing equipment elements 108, 110. Alternatively or additionally, a list of subscribers may be determined by service personnel and entered into network management system 107.

At block 204 (FIG. 2), a test is performed to ascertain whether or not a network management system for managing the new equipment elements (such as network management system 107, FIG. 1) supports logical provisioning of subscribers on the new equipment elements before the new equipment elements are placed into service. If not, the set of new equipment elements 112, 114 (FIG. 1) are installed in the communications network, subscriber connections are installed to the set of new equipment elements, and the set of new equipment elements are placed into service (FIG. 2, block 205). The set of new equipment elements are provisioned for the list of subscribers (block 206), and the procedure continues to block 209 (to be described in greater detail hereinafter).

The affirmative branch from block 204 leads to block 207 where the set of new equipment elements 112, 114 (FIG. 1) are preprovisioned for the list of subscribers. Next, at block 208 (FIG. 2), the set of new equipment elements 112, 114 (FIG. 1) are installed in communications network 120, and subscriber connections are installed to the set of new equipment elements. The procedures of block 208 (FIG. 2) could be performed simultaneously or in any order. For example, subscriber connections could be installed before the equipment elements are installed into the communications network. Moreover, depending upon the particularities of the new equipment elements, installing subscriber connections may, in fact, also constitute installing these new equipment elements into the network.

At block 209, subscriber connections to the set of existing equipment elements 108, 110 (FIG. 1) are removed. However, this step need not be performed in situations where the existing equipment elements and the connections thereto are destroyed or inaccessible. Optionally, at block 211 (FIG. 2), the set of existing equipment elements 108, 110 is removed from communications network 120 (FIG. 1).

As described above, the present invention can be embodied in the form of computer-implemented processes and apparatuses for practicing those processes. The present invention can also be embodied in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for reducing down time of a communications network while performing network modifications, the method comprising:
determining a list of subscribers to be moved from a set of existing equipment elements to a set of new equipment elements;
if a network management system for managing the set of new equipment elements is capable of supporting logical provisioning of subscribers before the set of new equipment elements are placed into service, then preprovisioning the set of new equipment elements for the list of subscribers, installing subscriber connections to the set of new equipment elements and installing the set of new equipment elements in the communications network; otherwise, installing subscriber connections to the set of new equipment elements, installing the set of new equipment elements into the communications network, placing the set of new equipment elements into service, and provisioning the set of new equipment elements for the list of subscribers; and
removing subscriber connections to the set of existing equipment elements.

2. The method of claim 1 further comprising removing the set of existing equipment elements from the communications network.

3. The method of claim 1 further including updating subscriber connections to the set of new equipment elements in a network management system.

4. The method of claim 1 wherein the set of existing equipment elements is destroyed by a natural disaster.

5. The method of claim 1 wherein the set of new equipment elements are capable of providing an internet protocol based communication service to one or more subscribers.

6. The method of claim 1 wherein the set of existing equipment elements are capable of providing an asynchronous transfer mode based communication service to one or more subscribers.

7. The method of claim 1 wherein the communications network is a public switched telephone network.

8. A computer program product for reducing down time of a communications network while performing network modifications, the computer program product comprising a storage medium readable by a processing circuit and storing instructions for execution by the processing circuit for facilitating a method comprising:
determining a list of subscribers to be moved from a set of existing equipment elements to a set of new equipment elements;
if a network management system for managing the set of new equipment elements is capable of supporting logical provisioning of subscribers before the set of new equipment elements are placed into service, then preprovisioning the set of new equipment elements for the list of subscribers, installing subscriber connections to the set of new equipment elements and installing the set of new equipment elements in the communications network; otherwise, installing subscriber connections to the set of new equipment elements, installing the set of new equipment elements into the communications network, placing the set of new equipment elements into service, and provisioning the set of new equipment elements for the list of subscribers; and
removing subscriber connections to the set of existing equipment elements.

9. The computer program product of claim 8 further comprising instructions for removing the set of existing equipment elements from the communications network.

10. The computer program product of claim 8 further including instructions for updating subscriber connections to the set of new equipment elements in a network management system.

11. The computer program product of claim 8 wherein the set of existing equipment elements is destroyed by a natural disaster.

12. The computer program product of claim 8 wherein the set of new equipment elements are capable of providing an internet protocol based communication service to one or more subscribers.

13. The computer program product of claim 8 wherein the set of existing equipment elements are capable of providing an asynchronous transfer mode based communication service to one or more subscribers.

14. The computer program product of claim 8 wherein the communications network is a public switched telephone network

15. A system for reducing down time of a communications network while performing network modifications, the system including:
a network management mechanism for managing a set of new equipment elements and for determining a list of subscribers to be moved from a set of existing equipment elements to the set of new equipment elements such that, if the network management mechanism is capable of supporting logical provisioning of subscribers before the set of new equipment elements are placed into service, then the network management mechanism preprovisions the set of new equipment elements for the list of subscribers before the set of new equipment elements is placed into service; otherwise, the network management mechanism provisions the set of new equipment elements for the list of subscribers after the set of new equipment elements is placed into service;
a communications network operably coupled to the network management mechanism, wherein the communications network is modified by installing the set of new equipment elements in the communications network, by installing subscriber connections to the set of new equipment elements, and by removing subscriber connections to the set of existing equipment elements, and wherein the modified network is capable of providing communication service to the list of subscribers using the set of new equipment elements.

16. The system of claim 15 wherein the set of existing equipment elements is removed from the communications network.

17. The system of claim 15 wherein the network management mechanism includes a subscriber database associating each of a plurality of subscribers with corresponding equipment elements, and the database is updated by associating one or more corresponding new equipment elements with each of a plurality of subscribers.

18. The system of claim 15 wherein the set of existing equipment elements is destroyed by a natural disaster.

19. The system of claim 15 wherein the set of new equipment elements are capable of providing an internet protocol based communication service to one or more subscribers.

20. The system of claim 15 wherein the set of existing equipment elements are capable of providing an asynchronous transfer mode based communication service to one or more subscribers.

21. The system of claim 1 wherein the communications network is a public switched telephone network.
